(19) United States
(12) Patent Application Publication
(10) Pub. No.: US 2016/0075173 A1
(43) Pub. Date: Mar. 17, 2016

(54) PAINTER'S PALETTE

(71) Applicant: Chris Edgar Hutton, SPERRY, OK (US)

(72) Inventor: Chris Edgar Hutton, SPERRY, OK (US)

(21) Appl. No.: 14/485,349

(22) Filed: Sep. 12, 2014

(51) Int. Cl. B44D 3/02; B65D 25/34; B65D 1/34; B65D 25/14; B65D 43/02; B65D 25/04

(52) U.S. Cl. CPC B44D 3/02; B65D 43/02; B65D 25/04; B65D 1/34; B65D 25/14; B65D 25/34; B65D 2543/00268

(57) ABSTRACT

There is provided herein an artist's palette that comprises a coated paper product that is formed into a container for containing paint that is used in painting. In some embodiments, the coating will be silicone or acrylic which will tend to make the paper impervious to paint. In some embodiments, the container might take the form of a generally rectangular shape with sidewalls. In other embodiments, the inventive palette might be accompanied by a matching lid which could be made of the same or similarly treated paper. In some further embodiments, the invention might be constructed with some number of internal compartments into which different colored paints could be placed. In such an instance, the internal walls in an embodiment would utilize the same coated paper as was utilized in the palette.

### FIELD OF THE INVENTION

This disclosure relates to the general subject of devices to assist an artist and, more particularly, to devices that function as an artist's palette.

### BACKGROUND OF THE INVENTION

A palette traditionally takes the form of a flat rigid service on which a painter deposits and mixes paints that are being used in a painting. A conventional palette might be made of wood, acrylic plastic, glass, ceramics, or some other nonporous material. Wooden palettes have been used for hundreds of years and still remain a staple today for oil and water painters. Such palettes often take the form of a thin generally oval panel which a hole cut therein might be designed to be held in the artist's arm where it can be readily accessed by the other hand that holds the brush. Wooden palettes may be treated using linseed or another oil.

In some cases, the palette might be too large or heavy to be held during painting and instead it would then be placed on a support surface adjacent the easel. In some cases, the palette might be incorporated into and/or attachable to the easel as well. Watercolor palettes are often made of plastic or porcelain and may include built in wells or other mixing areas for colors.

Of course, one disadvantage of hard palette is that they may be difficult to clean depending on the materials from which they are constructed. Further, storing the palette with wet paint on it for subsequent use in the future may or may not be feasible. Of course, paint that is deposited on a palette will predictably dry over time unless it is protected somehow. That may make resuming painting with the previously used paint impractical and could result in waste of some amounts of expensive paints. Additionally, where a particular ad hoc mixture of paints has been created on the palette for use in a painting, it might be difficult or impossible to recreate exactly that same value at some time in the future if the current mixture becomes unusable due to drying. Keeping it in a cold environment (e.g., in a refrigerator or freezer) will also slow drying.

As a consequence, it is known that a hard palette or other support surface can be covered with a paper palette with the intention that the paint should be deposited thereon. In such an instance, the hard surface might be intended to provide support to the more flexible paper palette during painting. Typically, a paper palette is inexpensive and made to be disposable which obviates the need to clean the support surface. Alternatively, when it is desired to maintain the paint on the paper in a wet state until it can be used subsequently, some paper palette are designed to be removed and stored in a separate enclosure which reduces the amount of drying that occurs. Alternatively, in some instances the support surface itself might be configured in such a way that it might be folded or closed to reduce air circulation and retard drying.

It has been recognized in the art that common paper may not provide a satisfactory palette material for use with most paints. For example, paper tends to be too absorbent and/or lacks to the sufficient strength when wet to be readily used as a palette. Thus, it is known to apply certain kinds of coatings to a paper to create a palette that is impermeable with respect to paint. Sometimes polyethylene is used as a coating. However, this sort of coating is not desirable in some instances because it results in a palette that has a glossy surface that reflects ambient light. That can interfere with or distract from the painting process. Additionally, application of the polyethylene coating might involve lamination which adds at least one step to the manufacturing process and increases the cost of the final product.

However, such a prior art palette may not be entirely satisfactory. For example, commercially available palettes are flat pieces of paper that are placed on top of or within another object. Such an arrangement allows paint to travel from the paper onto the support surface which will then need to be cleaned. Additionally, the resulting palette is not suitable for storage of the paints contained thereon except when placed within a separate container. More particularly, although it might be desirable to remove the paper palette from the support surface and, for example, store it separately, the prior art thin sheets of paper that are used for this purpose are not amendable to such relocation.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

Other embodiments and variations are certainly possible within the scope of the instant invention and can readily be formulated by those of ordinary skill in the art based on the disclosure herein.

According to an embodiment there is provided an artist's palette that comprises a coated paper product that is formed into a container for containing the paint. In some embodiments, the coating will be silicone or acrylic which will tend to make the paper relatively impervious to paint. In some embodiments, the inventive palette might be configured in a generally rectangular shape with sidewalls. In other embodiments, the inventive palette might be accompanied by a matching lid which might be additionally made of similarly treated paper. In some further embodiments, the invention might be constructed with some number of internal compartments into which different colored paints could be placed. In such an instance, the internal walls in an embodiment would utilize the same coated paper as was utilized in the palette.

The foregoing has outlined in broad terms the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains a plan view of an artist's easel which includes an embodiment.

FIG. 2 contains a front view of an embodiment as it might appear in use within a pochade box that is supported by a tripod of the sort that might be used with a camera.

FIG. 3 contains a front perspective view of the embodiment of FIG. 1.

FIG. 4 contains an embodiment together with a matching lid.

FIG. 5 contains an embodiment which includes some number of internal partitions.

FIG. 6 contains a schematic illustration of an embodiment which provides greater detail with respect to how such might be constructed.

### DETAILED DESCRIPTION OF THE PREFERRED EMBODIMENTS

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

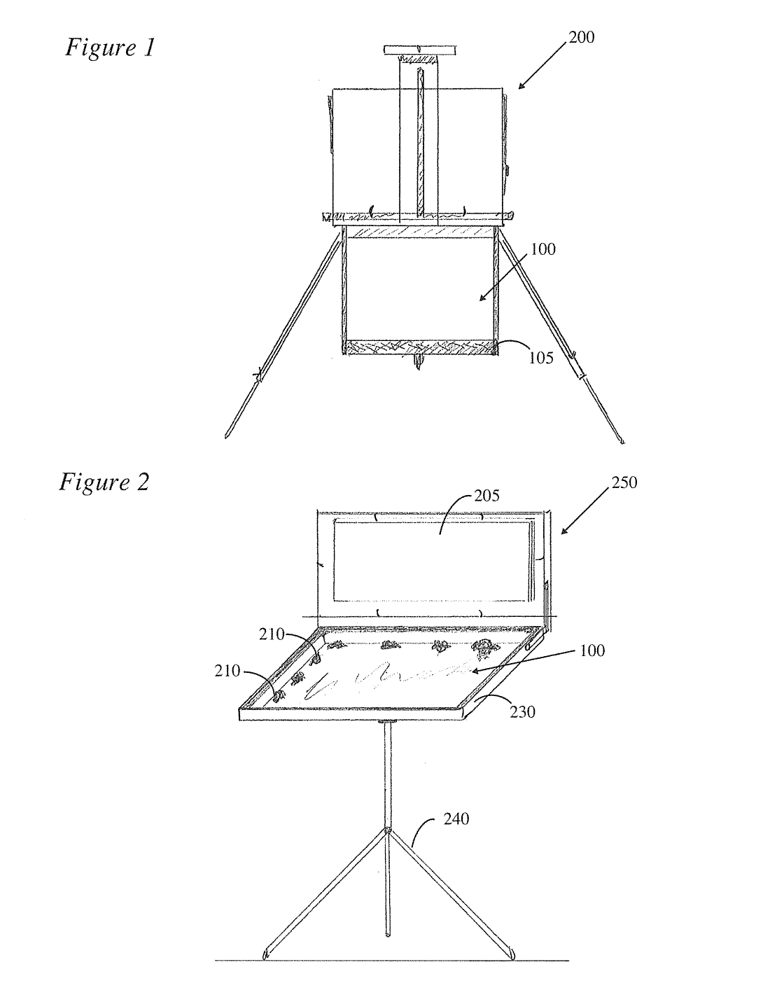

According to an embodiment and turning first to FIG. 4, there is provided an artists' palette 100 that will be configured as a shallow box which is formed from a single sheet of a specially selected coated paper product which is described in greater detail below. As can be seen in FIGS. 1-3, some embodiments will be utilized in conjunction with an artist's easel and, in those embodiments, the device 100 would preferably be shaped to match the interior of the receptacle into which it is placed.

In some embodiments, the artist's palette 100 will be designed to be surmounted by a matching lid 120 which is intended to be placed atop the palette 100 when a work in progress cannot be completed in one sitting (e.g. FIG. 4). Such a lid 120 would obviously be sized to mate with the palette 100 as is conventionally done. The use of such a lid would help to keep the paint that is contained therein from contacting other objects during the times that it is transported and would also tend to retard the drying process. Additionally, affixing the lid 120 to the palette 100 would reduce the risk of contamination of the paint from dust, dirt, etc., while it is being transported or stored.

Turning now to an important aspect of the invention, in some embodiments a coated paper product will be used to form the inventive palette 100, with the coating either being silicone or acrylic. These two coatings have been determined to be desirable because they will tend to make the paper to which they are applied relatively impervious to paint, thereby preventing the paint from contacting the underlying surface.

Silicone is, of course, is a well-known water and heat resistant material. It is generally nontoxic and very stable chemically (nonreactive) and is used in a variety of different contexts. The term “silicone” actually includes a number of silicon-based compounds (silicon polymers). However, it is important for purposes of the instant invention that the particular silicon-based compound that is chosen for use in connection with the instant invention at least be nonreactive to the particular variety of paint that is to be applied to the palette 100. Further, application of the silicon-based compound to the chosen paper must create an impermeable barrier with respect to chosen paint.

Acrylic is a water-based emulsion that provides the requisite functionality the instant invention requires (e.g., barrier forming when applied to the paper of choice). It is a common constituent of latex paint, gesso, etc. In addition to making the paper to which it is applied impermeable, an acrylic coating also provides a pH neutral barrier that allows the palette to be maintained indefinitely and in an “archival” condition. This aspect would allow the palette to serve as a record of the painting if the artist so chooses.

In one embodiment, the paper/coating combination of choice for use in forming the palette 100 will be SBS (i.e., solid bleached sulfate, sometimes known as sold bleached board, SBB) board. Other sorts of paper might also be used including WLC (white lined clipboard, a multi-layer product used in packaging applications that contains recycled fibers), solid unbleached board (SUB, paperboard made form unbleached paperboard which might be found, for example, in food containers, toys, shoes, and cleaning containers), etc.

No matter which type of board is chosen, an important step in preparing it for use according to the teachings herein would be to apply a 6 BCM (Billion Cubic Micron) coating weight of acrylic. In some embodiments, the acrylic coating will be applied using an annilox roller in a manner that is reminiscent of the techniques that are used in the printing industry. However, in some embodiments a silicone layer will be flooded onto the surface of the paper. Either way, it is critical to the operation of the instant invention that sufficient coating be applied to make the paper substantially impervious to the paint that is deposited thereon. Various weights of coatings might be used according to the goals of the instant invention and weights from about 2 to 10 BCM would be suitable in some embodiments, although those limits should be regarded as being preferred, not required.

SBS and other boards are widely available commercially (e.g., from Georgia Pacific®, MeadWestvaco®, Potlatch®, etc.) and can be found in many applications (e.g., Fed Ex® overnight mailers, shotgun shell boxes, cosmetic containers, auto parts containers, food containers, etc.) where a relatively heavy paper is required. With respect to SBS board, this type of paper is typically provided by the manufacturer with an uncoated “front” side that would be suitable for application of silicone or acrylic according to the instant invention. It also conventionally has a back or raw side that might have visible imperfections thereon. Additionally, the backside of SBS might have a clay coating and/or printing thereon which would argue that it would not be best to coat only this side according to the invention. That being said, in some instances it might be useful to apply the coating to the raw side of the SBS paper because it might have better adhesion properties.

Some embodiments of the instant invention will utilize a 20 caliper (or point) board which translates to a thickness of about 0.020 inches. More generally, however, the weight of the board should be chosen so that the paper has sufficient rigidity to be formed into a container with sidewalls. Additionally, some embodiments will be thick enough to be removed as a unit from the easel, utilized as a container for the artwork, etc. Thus, calipers from about 14 to 24 could potentially be useful in some embodiments, although calipers outside that range might also be utilized in certain circumstances. Other thicknesses such as 15, 16, 18, 20, 24, and 30 point board might also be used. However, those of ordinary skill in the art will readily be able to choose other weights to accommodate the goals of the instant invention. That being said, it is important that the paper be thick enough to hold its shape after being formed into a container. It should also be strong enough to preload paint.

As is more clearly evident from FIGS. 4 and 5, this embodiment of the invention 100 is generally rectangular in shape and has upturned edges somewhat like the lower portion of a shallow box. In some embodiments, it will be formed from a single sheet of coated paper to help prevent leakage of the paint contained therein into the receptacle that contains it.

In some embodiments, the invention 500 might be configured to include some number of internal compartments 505 into which different paints could be placed. In this case, the dividers that separate the compartments would preferably be made of the same paper as the exterior of the palette 500, thereby making them impervious to the paint held within and preventing mixing of the associated paints.

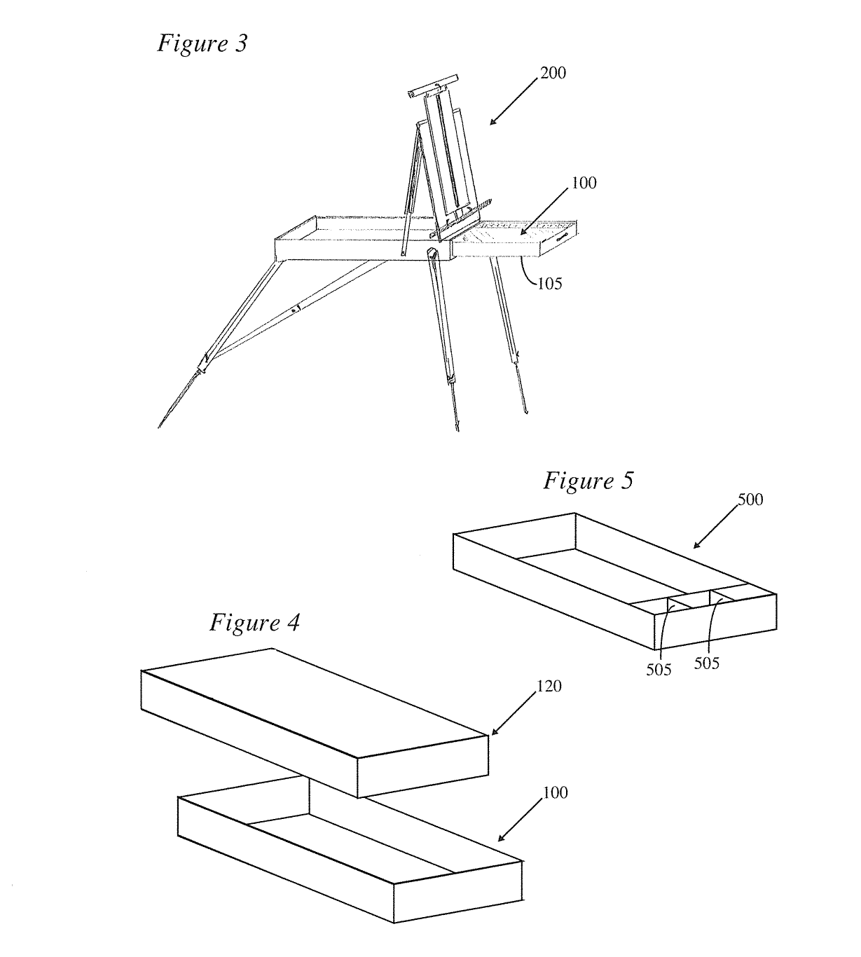

Turning next to FIG. 1, in this figure there is contained a plan view of an embodiment of the instant artist's palette 100 as it might appear when in use. In this particular variation, an artist's easel 200 has been equipped with a drawer 105 which will be used to contain the palette 100. This can be more clearly seen in FIG. 3.

FIG. 3 contains an illustration of a side view of the easel 300 together with an embodiment of the instant invention 100 which has been removed from the drawer 105 to make it more readily examined.

A principal function of an embodiment of the instant palette 100 is to allow an artist to mix various colored paints together to obtain a customized value during production of a painting, as is conventionally done. FIG. 2 contains an illustration of a pochade box-type easel 250 containing an embodiment of the palette 100 that illustrates how this might appear in practice. In this variation of the invention, the easel 250 is supported by a tripod 240 of the sort that might be used with a camera. The lower compartment 230 of the easel 250 contains the working paints 210 of the artist which have been deposited within an embodiment of the inventive palette 100. As is conventionally done, a subject artwork 205 is shown as being mounted in an upper compartment of the easel 250.

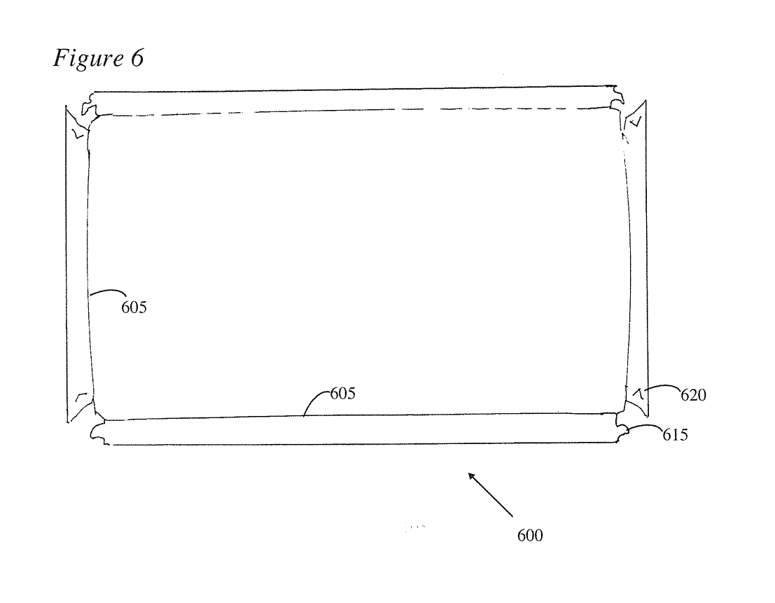

Turning next to FIG. 6, in this embodiment a single sheet of coated paper is pre-cut to be formed into a shallow box of the sort suitable for use as a palette. More particularly, in this embodiment, the palette 600 has been cut to make it easy to assemble. In this embodiment, the palette 600 has been provided with score lines 605 along which the palette 600 is to be folded. Additionally, in this embodiment tabs 615 and slots 620 have been cut into the palette 600 so that it can readily be formed into a container. Of course, those of ordinary skill in the art will recognize that there are many ways by which a coated paper palette might be configured into a container (e.g., adhesives of various types, hook and loop fabric, etc.)

It should be noted that in some embodiments the instant palette might be sized to accommodate a work of art therein for purposes of transporting it (e.g., from home to the site where the painting is to be prepared). Of course, in that instance the strength and rigidity of the instant palette would need to be increased appropriately. Those of ordinary skill in the art will readily be able to determine the parameters to create such a palette.

In other embodiments the instant palette might be made of archival and/or pH neutral paper so that it could potentially be stored indefinitely. Those of ordinary skill in the art will recognize the advantage of using this sort of paper, among them being that the palette itself might be then stored as a record of the painting if the artist so chooses.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An artist's palette for use with acrylic, watercolor or oil paint, comprising a single sheet of coated paper formed into a shallow container, said coated paper having been coated with silicone or acrylic at a weight sufficient to cause said coated paper to be substantially impermeable to said acrylic, watercolor, or oil paint.

2. The palette according to claim 1 wherein said paper has a thickness between about between about 14 caliper and 24 caliper.

3. The palette according to claim 1, wherein said silicone or acrylic are coated onto said sheet of paper at a weight of between about 2 and 10 BCM.

4. The palette according to claim 1, further comprising a lid sized to mate with and cover said artist's palette.

5. The palette according to claim 4, wherein said lid is formed of a same coated paper as is used in said artist's palette.

6. The palette according to claim 1, wherein said paper is coated on both sides.

7. The palette according to claim 1, wherein said palette is formed to fit within a drawer of an artist's easel.

8. The palette according to claim 1, wherein said single sheet of paper is chosen from the group consisting of SBS paper, WLC paper, and SUB paper.

9. The palette according to claim 1, further comprising a plurality of internal dividers, said plurality of dividers creating at least two compartments within said shallow container, wherein each of said plurality of internal dividers is made from a same kind of coated paper as said container.

11. An artist's palette for use with acrylic, watercolor or oil paint, comprising coated paper formable into a shallow container,
wherein said coated paper is coated with silicone or acrylic in a weight sufficient to cause said coated paper to be substantially impermeable to said acrylic, watercolor, or oil paint.

12. The palette according to claim 1 wherein said paper has a thickness between about between about 14 caliper and 24 caliper.

13. The palette according to claim 1, wherein said silicone or acrylic are coated onto said paper at a weight of between about 2 and 10 BCM.

14. The palette according to claim 1, further comprising a lid sized to mate with and cover said artist's palette.

15. The palette according to claim 4, wherein said lid is formed of a same coated paper as is used in said artist's palette.

16. The palette according to claim 1, wherein said paper is coated on both sides.

17. The palette according to claim 1, wherein said paper is formable to fit within a drawer of an artist's easel.

18. The palette according to claim 1, wherein said coated paper is chosen from the group consisting of SBS paper, WLC paper, and SUB paper.
